(19) United States
(12) Patent Application Publication
(10) Pub. No.: US 2010/0312934 A1
(43) Pub. Date: Dec. 9, 2010

(54) System and Method for Multi-Protocol Bus Communications

(75) Inventors: Shyh-An Chi, Hsin-Chu (TW); Jyy Anne Lee, Taipei (TW); Yung-Lo Li, Hsin-Chu (TW); Shih-Chi Wu, Zhubei City (TW)

Correspondence Address: SLATER & MATSIL, L.L.P., 17950 PRESTON ROAD, SUITE 1000, DALLAS, TX, 75252, US

(73) Assignees: Taiwan Semiconductor Manufacturing Company, Ltd., Hsin-Chu (TW); Global Unichip Corporation, Hsinchu Science Park (TW)

(21) Appl. No.: 12/762,991

(22) Filed: Apr. 19, 2010

Related U.S. Application Data
(60) Provisional application No. 61/184,603, filed on Jun. 5, 2009.

(51) Int. Cl. G06F 13/40

(52) U.S. Cl. 710/110

(57) ABSTRACT

A system and method for multi-protocol bus communications between integrated circuits is provided. An electronic system comprises an integrated circuit having an on-chip bus. The integrated circuit includes a master component and a first slave component, both coupled to the on-chip bus and communicate using a first on-chip bus protocol, a slave bus converter coupled to the on-chip bus, and a switch coupled to the slave bus converter and to the on-chip bus. The electronic system further comprising a second slave component coupled to the integrated circuit. The slave bus converter converts bus communications in the first on-chip bus protocol to a second on-chip bus protocol and the switch selectively couples the on-chip bus or the slave bus converter to the second slave component based on a bus select control signal.

This application claims the benefit of U.S. Provisional Patent Application Ser. No. 61/184,603, filed on Jun. 5, 2009, and entitled “System and Method for Multi-Protocol Bus Communications,” which application is incorporated herein by reference.

### TECHNICAL FIELD

The present invention relates generally to communications between integrated circuits, and more particularly to a system and method for multi-protocol bus communications between integrated circuits.

### BACKGROUND

Continued advances in integrated circuit fabrication technology have permitted the creation of systems-on-a-chip (SOC), wherein most if not all components required for a computer system or electronic system are integrated into a single integrated circuit (chip). Generally, a SOC may contain digital, analog, mixed-signal, radio frequency (RF) circuits, all on one chip. In situations wherein a SOC is not practical, a system-in-a-package (SiP) may be used to create a system over multiple chips conveniently packaged into a single module. A SiP may include a number of chips combined together and then placed on a substrate or individual chips placed on a substrate(s) or a combination thereof. Another name for a SiP may be a multi-chip module (MCM).

Generally, in a SOC or a SiP, the various circuits, components, functional blocks, and so forth, may communicate with one another over a SOC on-chip bus using an on-chip bus protocol. The use of the SOC on-chip bus may allow for easy expansion by adding additional circuits, components, functional blocks, and so forth, to the SOC or SiP. FIG. 1 is a diagram illustrating a SOC 100. SOC 100 includes a number of components, such as master component 1 105, master component N 107, slave component 1 110, and slave component M 112. The components may communicate over a SOC on-chip bus 115, making use of an on-chip bus protocol. A master component may initiate communications to a slave component, while a slave component may only respond to communications from a master component.

In addition to the components internal to SOC 100, additional external circuitry may attach to SOC 100. As shown in FIG. 1, chip X 120 and SOC Z 125 may attach to SOC 100. Components in chip X 120 and SOC Z 125 may communicate with the components in SOC 100 over SOC on-chip bus 115 using on-chip bus protocol. Chip X 120 and SOC Z 125 may contain master components, slave components, or a combination of both.

In general, chip X 120 and SOC Z 125 may contain master components, slave components, or a combination of both, which from the perspective of SOC 100 need to communicate with SOC 100.

However, in order for components in chip X 120 and SOC Z 125 to communicate with the components in SOC 100, the components in chip X 120 and SOC Z 125 must communicate using the same on-chip bus protocol as the components in SOC 100, or the on-chip bus protocol must somehow be compatible. If the components do not communicate using the same or compatible on-chip bus protocol, then they may not be able to communicate. If the components do not communicate using the same or compatible on-chip bus protocol, then it may be necessary to re-tapeout SOC 100 or SOC T 205, which may incur additional costs for NRE, masking, testing, and so forth.

FIG. 2 is a diagram illustrating SOC 100. As shown in FIG. 2, components in chip X 120 communicate using the same on-chip bus protocol as the components in SOC 100, therefore, the components of chip X 120 and SOC 100 are able to communicate. However, components of SOC T 205 do not communicate using the same on-chip bus protocol as do the components of SOC 100, therefore, the components of SOC T 205 and SOC 100 are not able to communicate.

FIG. 3 is a diagram illustrating a prior art system interface processor (SIP) 300. SIP 300 provides a virtual multi-protocol bus system that includes a plurality of protocol indicators associated with an address space with each protocol indicator associated with a segment of the addressed space and configured to indicate a particular bus protocol. SIP 300 makes use of control lines to implement a particular bus protocol in accordance with a selected protocol indicator based on an address segment of the address space.

SIP 300 includes a multi-protocol bus system 312 that dynamically implements a particular bus protocol on a multi-protocol bus 390 when communicating with or controlling devices 350, 360, 370, and 380. To communicate with one of devices 350-380, a PCI interface 310 writes to or reads from the device's address space and the multi-protocol bus system 312 determines which particular bus protocol to use based on that address space and implements that bus protocol.

As shown in FIG. 3, SIP 300 operates with devices within the same chip. Therefore, devices that are off-chip (such as external masters or external slaves) may not be able to communicate using SIP 300.

### SUMMARY OF THE INVENTION

These and other problems are generally solved or circumvented, and technical advantages are generally achieved, by embodiments of a system and a method for multi-protocol bus communications between integrated circuits.

In accordance with an embodiment, an electronic system is provided. The electronic system includes an integrated circuit having an on-chip bus. The integrated circuit includes a master component coupled to the on-chip bus, a first slave component coupled to the on-chip bus, a slave bus converter having a first bus terminal coupled to the on-chip bus, and a switch having a first switch terminal coupled to a second bus terminal of the slave bus converter and a second switch terminal coupled to the on-chip bus and a third switch terminal coupled to a terminal of the integrated circuit. The master component communicates using bus communications over the on-chip bus in a first on-chip bus protocol, the first slave component responds to bus communications, and the slave bus converter converts bus communications in the first on-chip bus protocol received at the first bus terminal into bus communications in a second on-chip bus protocol. The switch selectively couples the first switch terminal or the second switch terminal to the third switch terminal based on a bus select control signal. The first slave component communicates using bus communications in the first on-chip bus protocol. The electronic device also includes a second slave component coupled to the terminal of the integrated circuit. The second slave responds to bus communications. The second slave component communicates using bus communications in the second on-chip bus protocol.

In accordance with another embodiment, an electronic system is provided. The electronic system includes an integrated circuit having an on-chip bus. The integrated circuit includes a master component coupled to the on-chip bus, a first slave component coupled to the on-chip bus, a master bus converter having a first bus terminal coupled to a terminal of the integrated circuit, and a switch having a first switch terminal coupled to a second bus terminal of the master bus converter and a second switch terminal coupled to the terminal of the integrated circuit and a third switch terminal coupled to the on-chip bus. The master component communicates using bus communications over the on-chip bus in a first on-chip bus protocol, the first slave component responds to bus communications, and the master bus converter converts bus communications in a second on-chip bus protocol received at the first bus terminal into bus communications in the first on-chip bus protocol. The switch selectively couples the first switch terminal or the second switch terminal to the third switch terminal based on a bus select control signal. The first slave component communicates using bus communications in the first on-chip bus protocol. The electronic system also includes a second master component coupled to the terminal of the integrated circuit. The second master component initiates communications. The second master component communicates using bus communications in the second on-chip bus protocol.

In accordance with another embodiment, a method for providing bus communications to an external component connected to an integrated circuit is provided. The method includes detecting a first communications protocol used by the external component, setting a bus selector to use a passthrough path in response to determining that the first communications protocol is compatible to a second communications protocol used in the integrated circuit, and setting the bus selector to use a first converter in response to determining that the first communications protocol is incompatible with the second communications protocol used in the integrated circuit. The first converter converts transmissions in the first communications protocol into transmissions in the second communications protocol.

An advantage of an embodiment is that no additional costs are incurred (such as, non-recurring engineering (NRE), mask, test, fabrication, and so forth, costs) since an existing SOC or SiP does not have to be modified to allow the attachment of additional external components, peripherals, etc.

A further advantage of an embodiment is that existing (e.g., older or legacy versions) SOCs or SiPs that implement older or incompatible bus communications protocols may be used. This may allow for continued use of older or legacy components, which may help to reduce overall cost of products.

Yet another advantage of an embodiment is that external devices, components, and so forth, using different on-chip bus protocols may be connected to a SOC or SiP simultaneously and may be used substantially concurrently.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 is a diagram of a SOC;

FIG. 2 is a diagram of a SOC with an incompatible external component;

FIG. 3 is a diagram of a prior art system interface processor for use in providing a virtual multi-protocol bus system;

FIGS. 4a and 4b are diagrams of SOCs with external slave components attached to the SOCs;

FIGS. 5a and 5b are diagrams of SOCs with external master components attached to the SOCs;

FIGS. 6a and 6b are flow diagrams of processes for use in enabling communications between components in an SOC and external components attached to the SOC; and

FIGS. 7a and 7b are flow diagrams of processes for use in enabling communications between components in an SOC and external components attached to the SOC.

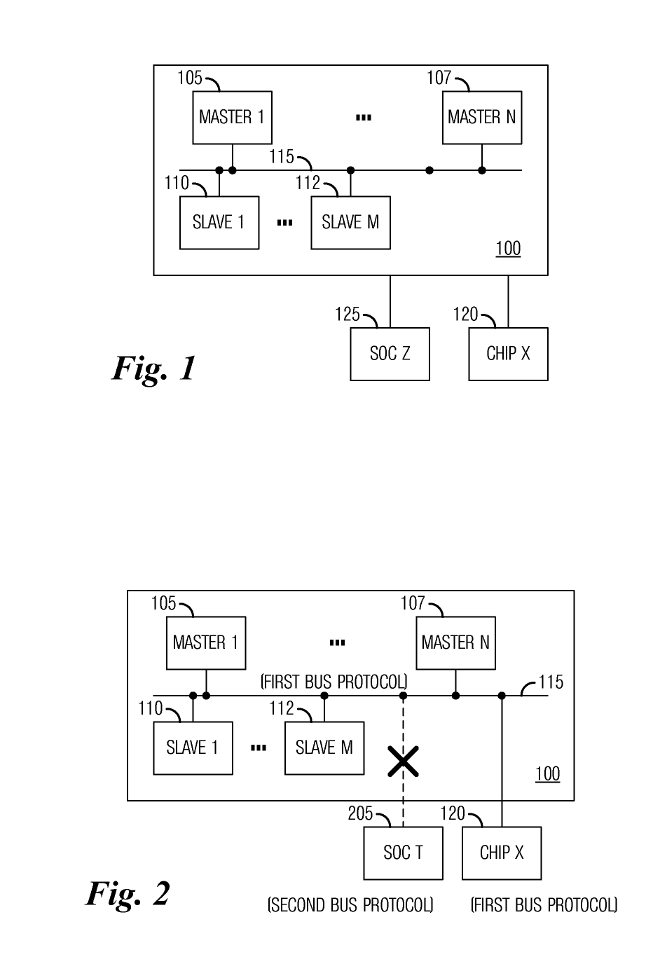

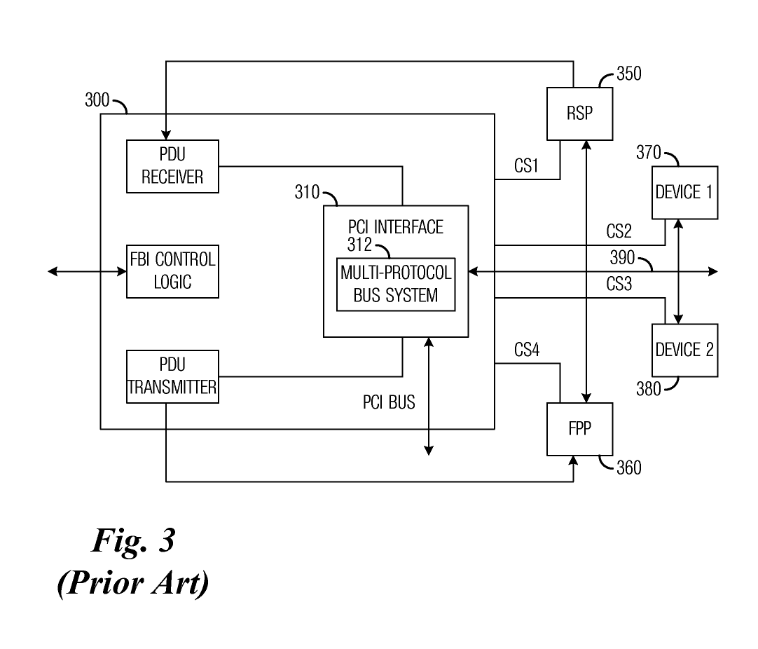

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a SOC having an external SOC on-chip bus capable of communicating using more than one on-chip bus protocols. The invention may also be applied, however, to other systems, such as SiP, MCM, and so forth.

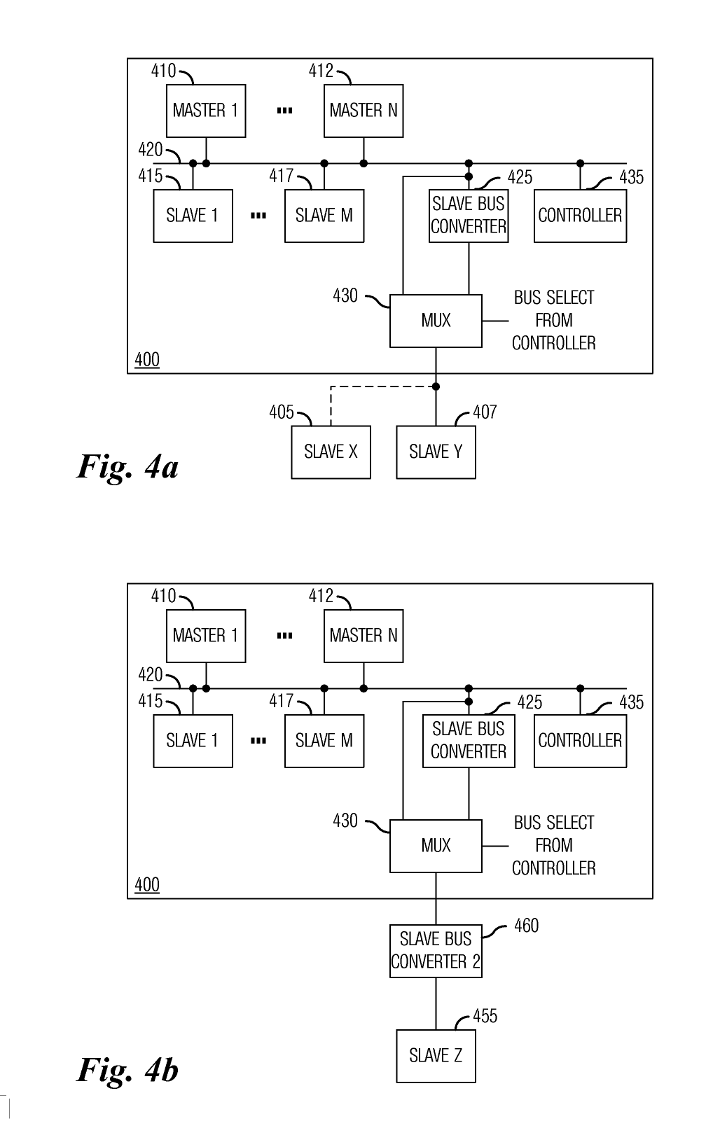

FIG. 4a is a diagram illustrating a SOC 400. SOC 400 may have several external components connected to SOC 400, such as slave component X 405 and slave component Y 407. As shown in FIG. 4a, the external components connected to SOC 400 are slave components, meaning that they may be capable of responding to communications only and not initiating communications. However, only a single type of slave component may communicate with SOC 400, namely, slave components that communicate using the same (or compatible) on-chip bus protocol as components in SOC 400. SOC 400 includes a number of components, such as a master component 1 410, a master component N 412, a slave component 1 415, and a slave component M 417. The components may communicate over a SOC on-chip bus 420, making use of a first on-chip bus protocol.

Slave component X 405 may be capable of communicating using the first on-chip bus protocol, while slave component Y 407 may be capable of communicating using a second on-chip bus protocol. Unfortunately, the first on-chip bus protocol may be incompatible with the second on-chip bus protocol. Therefore, slave component Y 407 may be incapable of communicating directly with components in SOC 400.

However, SOC 400 includes a slave bus converter 425 that may be used to perform conversion of communications in the first on-chip bus protocol into communications in the second on-chip bus protocol, and vice versa. Slave bus converter 425 may contain necessary information needed to perform the on-chip bus protocol conversion, including specific formats used in the on-chip bus protocols, signaling differences, signal level differences, data encoding differences, error detection/correction differences, and so forth.

A multiplexer 430 may allow SOC 400 to selectively couple SOC on-chip bus 420 or an output of slave bus converter 425 to an output terminal of SOC 400. The connection of SOC on-chip bus 420 to multiplexer 430 may be referred to as being a passthrough since no conversion is made to the communications. Multiplexer 430 may be controlled by a bus select signal. The bus select signal may be provided by a controller 435 that is a part of SOC 400 and may be responsible for controlling communications occurring in SOC 400. Alternatively, the bus select signal may be based on an input signal provided to SOC 400 or a programmable value stored in SOC 400. For example, when a component of SOC 400 is communicating with slave component X 405 the bus select signal may have multiplexer 430 may couple SOC on-chip bus 420 to the output terminal and bypass slave bus converter 425. However, when a component of SOC 400 is communicating with slave component Y 407 (which communicates using the second on-chip bus protocol) the bus select signal may have multiplexer 430 may couple the output of slave bus converter 425 to the output terminal of SOC 400, thereby allowing slave component Y 407 to communicate with SOC 400.

The on-chip bus protocol conversion performed by slave bus converter 425 may be bidirectional, meaning that slave bus converter 425 may be capable of converting communications from the first on-chip bus protocol into the second on-chip bus protocol, and vice versa. Similarly, multiplexer 430 may also operate as a demultiplexer. Alternatively, the on-chip bus protocol conversion performed by slave bus converter 425 may be unidirectional, meaning that slave bus converter 425 may be capable of converting communications from the first on-chip bus protocol into the second on-chip bus protocol, and a second slave bus converter may be used to perform the conversion of communications from the second on-chip bus protocol into the first on-chip bus protocol.

As shown in FIG. 4a, external components communicating using one of two on-chip bus protocols may be connected to SOC 400. If multiple external components are connected to SOC 400 and the multiple external components communicate using a single but incompatible on-chip bus protocol, the multiple external components may be connected to SOC 400, sharing the on-chip bus protocol conversion performed by slave bus converter 425. However, only external components that communicate using a single on-chip bus protocol may communicate with components of SOC 400 at a given time.

Additional slave bus converters may be present in SOC 400 to allow for communications with external components that communicate using other incompatible on-chip bus protocols.

FIG. 4b is a diagram illustrating an SOC 400 in an alternate embodiment for communicating with external components that communicate using a different on-chip bus protocol. As shown in FIG. 4b, SOC 400 may be connected to slave component Z 455. However, slave component Z 455 communicates using a third on-chip bus protocol, which may be incompatible to either the first on-chip bus protocol or the second on-chip bus protocol. A second slave bus converter 460 may be positioned between SOC 400 and slave component 455 to provide the on-chip bus protocol conversion between the first on-chip bus protocol and the third on-chip bus protocol.

Second slave bus converter 460 may be capable of performing bidirectional on-chip bus protocol conversion and may be used for both the first on-chip bus protocol to the third on-chip bus protocol conversion, and vice versa. Alternatively, second slave bus converter 460 may be capable of performing unidirectional on-chip bus protocol conversion (i.e., the first on-chip bus protocol to the third on-chip bus protocol conversion) and a third slave bus converter may be used to perform the third on-chip bus protocol to the first on-chip bus protocol conversion.

Additional slave bus converters may be connected to SOC 400 to allow other external components communicating using incompatible on-chip bus protocols to communicate with components in SOC 400. If multiple external components are connected to SOC 400 and the multiple external components communicate using a single but incompatible on-chip bus protocol, then the multiple external components may be connected to a single slave bus converter. Although additional slave bus converters may be connected to SOC 400 to allow for protocol conversion between multiple different on-chip bus protocols, according to an embodiment, at any given time, only external components communicating using a single on-chip bus protocol may communicate with SOC 400.

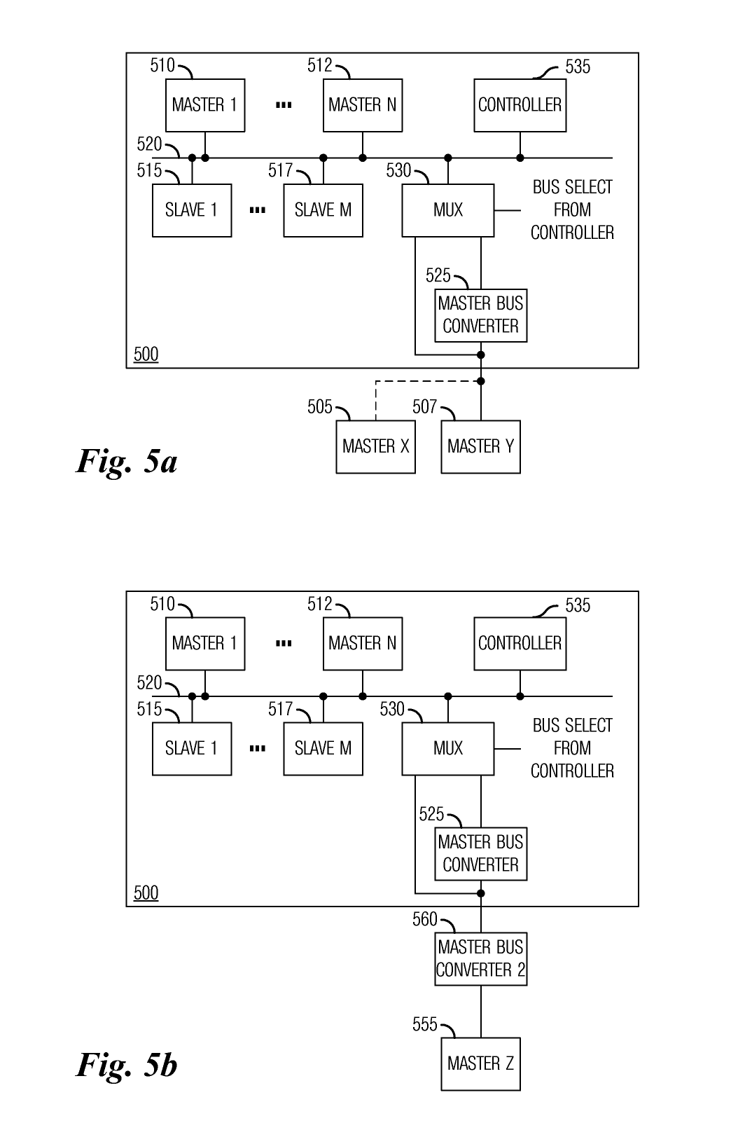

FIG. 5a is a diagram illustrating a SOC 500. SOC 500 may have several external components connected to SOC 500, such as master component X 505 and master component Y 507. As shown in FIG. 5a, the external components connected to SOC 500 are master components, meaning that they are capable of initiating communications to other master components or slave components. SOC 500 includes a number of components, such as a master component 1 510, a master component N 512, a slave component 1 515, and a slave component M 517. The components may communicate over a SOC on-chip bus 520, making use of a first on-chip bus protocol.

Master component X 505 may be capable of communicating using the first on-chip bus protocol, while master component Y 507 may be capable of communicating using a second on-chip bus protocol. Unfortunately, the first on-chip bus protocol may be incompatible with the second on-chip bus protocol. Therefore, master component Y 507 may be incapable of communicating directly with components in SOC 500.

However, SOC 500 includes a master bus converter 525 that may be used to perform conversion of communications in the first on-chip bus protocol into communications in the second on-chip bus protocol, and vice versa. Master bus converter 525 may contain necessary information needed to perform the on-chip bus protocol conversion, including specific formats used in the on-chip bus protocols, signaling differences, signal level differences, data encoding differences, error detection/correction differences, and so forth.

A multiplexer 530 may allow SOC 500 to selectively couple master component X 505 or master component Y 507 connected to an input terminal of SOC 500, or an output of master bus converter 525 to SOC on-chip bus 520 of SOC 500. The connection of the input terminal to multiplexer 530 may be referred to as being a passthrough since no conversion is made to the communications. Multiplexer 530 may be controlled by a bus select signal provided by a controller 535 that may be responsible for bus communications in SOC 500. Alternatively, the bus select signal may be based on an input signal provided to SOC 500 or a programmable value stored in SOC 500. For example, when master component X 505 is communicating with a component of SOC 500 multiplexer 530 may couple the input terminal to SOC on-chip bus 520 and bypass master bus converter 525. However, when master component Y 507 (which communicates using the second on-chip bus protocol) is communicating with a component of SOC 500 multiplexer 430 may couple the output of master bus converter 525 to SOC on-chip bus 520, thereby allowing master component Y 507 to communicate with SOC 500.

The on-chip bus protocol conversion performed by master bus converter 525 may be bidirectional, meaning that master bus converter 525 may be capable of converting communications from the first on-chip bus protocol into the second on-chip bus protocol, and vice versa. Similarly, multiplexer 530 may also operate as a demultiplexer. Alternatively, the on-chip bus protocol conversion performed by master bus converter 525 may be unidirectional, meaning that master bus converter 525 may be capable of converting communications from the first on-chip bus protocol into the second on-chip bus protocol, and a second master bus converter may be used to perform the conversion of communications from the second on-chip bus protocol into the first on-chip bus protocol.

As shown in FIG. 5a, external components communicating using one of two on-chip bus protocols may be connected to SOC 500. If multiple external components are connected to SOC 500 and the multiple external components communicate using a single but incompatible on-chip bus protocol, the multiple external components may be connected to SOC 500, sharing the on-chip bus protocol conversion performed by master bus converter 525. However, only external components that communicate using a single on-chip bus protocol may communicate with components of SOC 500 at a given time.

Additional master bus converters may be present in SOC 500 to allow for communications with external components that communicate using other incompatible on-chip bus protocols.

FIG. 5b is a diagram illustrating an SOC 500 in an alternate embodiment for communicating with external components that communicate using a different on-chip bus protocol. As shown in FIG. 5b, SOC 500 may be connected to master component Z 555. However, master component Z 555 communicates using a third on-chip bus protocol, which may be incompatible to either the first on-chip bus protocol or the second on-chip bus protocol. A second master bus converter 560 may be positioned between SOC 500 and master component Z 555 to provide the on-chip bus protocol conversion between the first on-chip bus protocol and the third on-chip bus protocol.

Second master bus converter 560 may be capable of performing bidirectional on-chip bus protocol conversion and may be used for both the first on-chip bus protocol to the third on-chip bus protocol conversion, and vice versa. Alternatively, second master bus converter 560 may be capable of performing unidirectional on-chip bus protocol conversion (i.e., the first on-chip bus protocol to the third on-chip bus protocol conversion) and a third master bus converter may be used to perform the third on-chip bus protocol to the first on-chip bus protocol conversion.

Additional master bus converters may be connected to SOC 500 to allow other external components communicating using incompatible on-chip bus protocols to communicate with components in SOC 500. If multiple external components are connected to SOC 500 and the multiple external components communicate using a single but incompatible on-chip bus protocol, then the multiple external components may be connected to a single slave bus converter. Although additional master bus converters may be connected to SOC 500 to allow for protocol conversion between multiple different on-chip bus protocols, according to an embodiment, at any given time, only external components communicating using a single on-chip bus protocol may communicate with SOC 500.

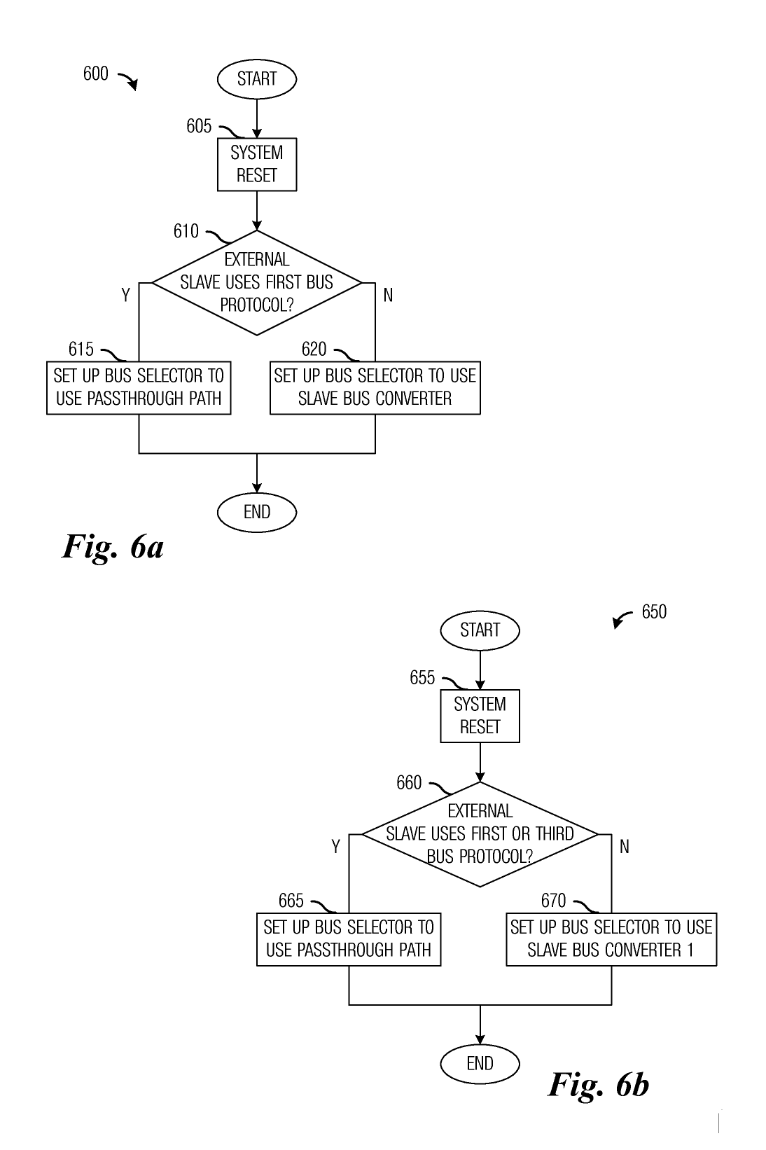

FIG. 6a is a flow diagram illustrating a process 600 for use in setting up communications between components in an SOC or SiP and external components connected to the SOC and SiP. Process 600 may be used to set up a bus select signal of a multiplexer, such as multiplexer 430, before communications may commence. Process 600 may be used in a configuration such as shown in FIG. 4a.

Process 600 may begin after a system reset (block 605). After a system reset, a check may be performed to determine if an external slave(s) connected to the SOC uses a first on-chip bus protocol (the same on-chip bus protocol used by components in the SOC) (block 610). If the external slave(s) communicates using the first on-chip bus protocol, then a bus selector may be set to use a passthrough path (block 615). But if the external slave(s) communicates using an incompatible on-chip bus protocol, then the bus selector may be set to use a slave bus converter (block 620). Process 600 may then terminate.

FIG. 6b is a flow diagram illustrating a process 650 for use in setting up communications between components in an SOC or SiP and external components connected to the SOC and SiP. Process 650 may be used to set up a bus select signal of a multiplexer, such as multiplexer 430, before communications may commence. Process 650 may be used in a configuration such as shown in FIG. 4b.

Process 650 may begin after a system reset (block 655). After a system reset, a check may be performed to determine if an external slave(s) connected to the SOC uses a first on-chip bus protocol (the same on-chip bus protocol used by components in the SOC) or a third on-chip bus protocol (the third on-chip bus protocol also being incompatible with the first on-chip bus protocol) (block 660). If the external slave(s) communicates using the third on-chip bus protocol, a second slave bus converter 460 may be used to convert the first on-chip bus protocol into the third on-chip bus protocol. If the external slave(s) communicates using the first on-chip bus protocol or the third on-chip bus protocol, then a bus selector may be set to use a passthrough path (block 665). But if the external slave(s) communicates using a second on-chip bus protocol, then the bus selector may be set to use a slave bus converter, e.g., slave bus converter 425 (block 670). Process 650 may then terminate.

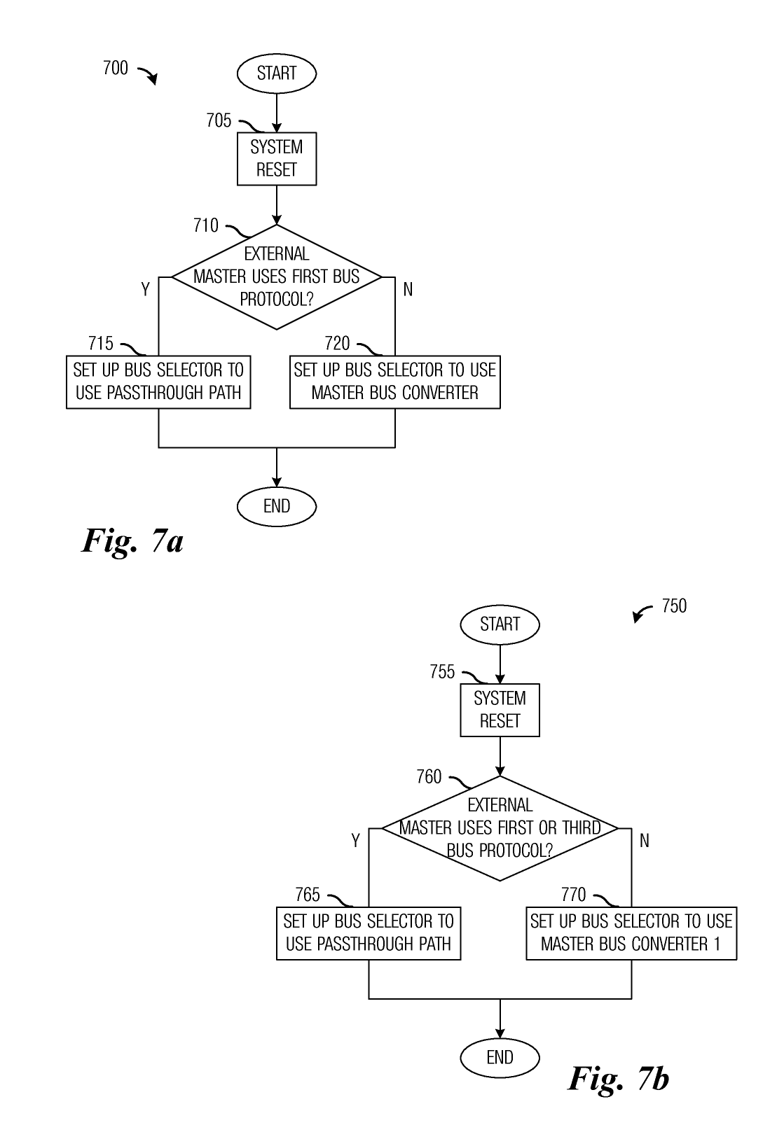

FIG. 7a is a flow diagram illustrating a process 700 for use in setting up communications between components in an SOC or SiP and external components connected to the SOC and SiP. Process 700 may be used to set up a bus select signal of a multiplexer, such as multiplexer 530, before communications may commence. Process 700 may be used in a configuration such as shown in FIG. 5a.

Process 700 may begin after a system reset (block 705). After a system reset, a check may be performed to determine if an external master(s) connected to the SOC uses a first on-chip bus protocol (the same on-chip bus protocol used by components in the SOC) (block 710). If the external master(s) communicates using the first on-chip bus protocol, then a bus selector may be set to use a passthrough path (block 715). But if the external master(s) communicates using an incompatible on-chip bus protocol, then the bus selector may be set to use a master bus converter (block 720). Process 700 may then terminate.

FIG. 7b is a flow diagram illustrating a process 750 for use in setting up communications between components in an SOC or SiP and external components connected to the SOC and SiP. Process 750 may be used to set up a bus select signal of a multiplexer, such as multiplexer 530, before communications may commence. Process 750 may be used in a configuration such as shown in FIG. 5b.

Process 750 may begin after a system reset (block 755). After a system reset, a check may be performed to determine if an external master(s) connected to the SOC uses a first on-chip bus protocol (the same on-chip bus protocol used by components in the SOC) or a third on-chip bus protocol (the third on-chip bus protocol also being incompatible with the first on-chip bus protocol) (block 760). If the external master(s) communicates using the third on-chip bus protocol, a second master bus converter 560 may be used to convert the third on-chip bus protocol into the first on-chip bus protocol. If the external master(s) communicates using the first on-chip bus protocol or the third on-chip bus protocol, then a bus selector may be set to use a passthrough path (block 665). But if the external master(s) communicates using a second on-chip bus protocol, then the bus selector may be set to use a master bus converter, e.g., master bus converter 525 (block 670). Process 750 may then terminate.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An electronic system comprising:
an integrated circuit having an on-chip bus, the integrated circuit comprising,
a master component coupled to the on-chip bus, the master component communicates using bus communications over the on-chip bus in a first on-chip bus protocol,
a first slave component coupled to the on-chip bus, the first slave component configured to respond to bus communications, wherein the first slave component communicates using bus communications in the first on-chip bus protocol,
a slave bus converter having a first bus terminal coupled to the on-chip bus, the slave bus converter configured to convert bus communications in the first on-chip bus protocol received at the first bus terminal into bus communications in a second on-chip bus protocol, and
a switch having a first switch terminal coupled to a second bus terminal of the slave bus converter and a second switch terminal coupled to the on-chip bus and an third switch terminal coupled to a terminal of the integrated circuit, the switch configured to selectively couple the first switch terminal or the second switch terminal to the third switch terminal based on a bus select control signal; and
a second slave component coupled to the terminal of the integrated circuit, the second slave configured to respond to bus communications, wherein the second slave component communicates using bus communications in the second on-chip bus protocol.

2. The electronic system of claim 1, wherein the integrated circuit further comprises a controller coupled to the on-chip bus and to the switch, the controller configured to generate the bus select signal based on bus communications on the on-chip bus.

3. The electronic system of claim 1, wherein the bus select signal is based on an input signal provided to the integrated circuit.

4. The electronic system of claim 1, wherein the bus select signal is based on a value stored in a memory in the integrated circuit.

5. The electronic system of claim 1, further comprising a third slave component coupled to the terminal of the integrated circuit, the third slave configured to respond to bus communications, wherein the third slave component communicates using bus communications in the first on-chip bus protocol.

6. The electronic system of claim 1, further comprising:
a second slave bus converter having a third bus terminal coupled to the terminal of the integrated circuit, the second slave bus converter configured to convert bus communications in the first on-chip bus protocol received at third bus terminal into bus communications in a third on-chip bus protocol; and
a fourth slave component coupled to a fourth bus terminal of the second slave bus converter, the fourth slave component configured to respond to bus communications, wherein the fourth slave component communicates using bus communications in the third on-chip bus protocol.

7. The electronic system of claim 1, wherein at any given time, the slave bus converter only converts communications between the first on-chip bus protocol and the second on-chip bus protocol.

8. The electronic system of claim 1, wherein the slave bus converter is further configured to convert bus communications in the second on-chip bus protocol received at the second bus terminal into bus communications in the first on-chip bus protocol.

9. The electronic system of claim 1, wherein the switch is further configured to selectively couple the third switch terminal to either the first switch terminal or the second switch terminal based on the bus select control signal.

10. An electronic system comprising:
an integrated circuit having an on-chip bus, the integrated circuit comprising,
a master component coupled to the on-chip bus, the master component communicates using bus communications over the on-chip bus in a first on-chip bus protocol,
a first slave component coupled to the on-chip bus, the first slave component configured to respond to bus communications, wherein the first slave component communicates using bus communications in the first on-chip bus protocol,
a master bus converter having a first bus terminal coupled to a terminal of the integrated circuit, the master bus converter configured to convert bus communications in a second on-chip bus protocol received at the first bus terminal into bus communications in the first on-chip bus protocol, and
a switch having a first switch terminal coupled to a second bus terminal of the master bus converter and a second switch terminal coupled to the terminal of the integrated circuit and a third switch terminal coupled to the on-chip bus, the switch configured to selectively couple the first switch terminal or the second switch terminal to the third switch terminal based on a bus select control signal; and
a second master component coupled to the terminal of the integrated circuit, the second master component configured to initiate communications, wherein the second master component communicates using bus communications in the second on-chip bus protocol.

11. The electronic system of claim 10, wherein the integrated circuit further comprises a controller coupled to the on-chip bus and to the switch, the controller configured to generate the bus select signal based on bus communications on the on-chip bus.

12. The electronic system of claim 10, further comprising a third master component coupled to the terminal of the integrated circuit, the third master configured to initiate to bus communications, wherein the third master component communicates using bus communications in the first on-chip bus protocol.

13. The electronic system of claim 10, further comprising:
a second master bus converter having third bus terminal coupled to the terminal of the integrated circuit, the second master bus converter configured to convert bus communications in a third on-chip bus protocol received at a fourth bus terminal into bus communications in the first on-chip bus protocol; and
a fourth master component coupled to the fourth bus terminal of the second master bus converter, the fourth master component configured to initiate bus communications, wherein the fourth master component communicates using bus communications in the third on-chip bus protocol.

14. The electronic system of claim 10, wherein at any given time, the master bus converter only converts communications between the second on-chip bus protocol and the first on-chip bus protocol.

15. The electronic system of claim 10, wherein the master bus converter is further configured to convert bus communications in the second on-chip bus protocol received at the second bus terminal into bus communications in the first on-chip bus protocol.

16. A method for providing bus communications to an external component connected to an integrated circuit, the method comprising:
detecting a first communications protocol used by the external component;
setting a bus selector to use a passthrough path in response to determining that the first communications protocol is compatible to a second communications protocol used in the integrated circuit; and
setting the bus selector to use a first converter in response to determining that the first communications protocol is incompatible with the second communications protocol used in the integrated circuit, wherein the first converter converts transmissions in the first communications protocol into transmissions in the second communications protocol.

17. The method of claim 16, further comprising setting the bus selector to use a passthrough path in response to determining that the first communications protocol is compatible to a third communications protocol, wherein a second converter converts transmissions in the third communications protocol into transmissions in the first communications protocol.

18. The method of claim 17, wherein the second converter is external to the integrated circuit.

19. The method of claim 16, wherein the detecting, the setting the bus selector to use a passthrough path, and the setting the bus selector to use a first converter occurs after a reset of the integrated circuit.

20. The method of claim 16, wherein the bus selector is set by a bus select control signal provided by a controller.
